(19) United States
(12) Patent Application Publication
(10) Pub. No.: US 2015/0239061 A1
(43) Pub. Date: Aug. 27, 2015

(54) PROCESS FOR WELDING WELD NUTS TO HIGH STRENGTH STEEL

(71) Applicant: Gestamp, Troy, MI (US)

(72) Inventors: Timothy M. Hamlock, Macomb, MI (US); Kevin Veenstra, Macomb, MI (US); Joshua Bower, Cross Lanes, WV (US)

(21) Appl. No.: 14/630,111

(22) Filed: Feb. 24, 2015

Related U.S. Application Data
(60) Provisional application No. 61/943,741, filed on Feb. 24, 2014.

(51) Int. Cl. B23K 11/14; B23K 11/00

(52) U.S. Cl. CPC B23K 11/14; B23K 11/004

(57) ABSTRACT

A process for projection welding a steel weld nut to an ultra high strength steel component using a direct current projection welding machine is provided. The process includes placing a steel weld nut at a predetermined location on the steel component such that the at least one projection of the weld nut is in direct contact therewith. The DC projection welding machine passes a current through the at least one projection that is in direct contact with the steel component a predetermined amount of weld time, which in turn creates a resistance weld joint between the weld nut and the steel component as is known to those skilled in the art. The predetermined amount of weld time is less than 1 Hz (16.67 sec) and the weld joint between the weld nut and the steel component has a twist off strength greater than 30.0 newton meters (Nm).

### CROSS-REFERENCE TO RELATED APPLICATION

This application claims priority of U.S. Provisional Patent Application Ser. No. 61/943,741 filed Feb. 24, 2014, which is incorporated in its entirety herein by reference.

### FIELD OF THE INVENTION

The present invention relates to a process for joining a weld nut to a component, and in particular to a process for welding a carbon steel weld nut to a high strength steel component.

### BACKGROUND OF THE INVENTION

The development and use of steels for the manufacture of a wide variety of components is known. In addition, the attachment of fasteners such as carbon steel weld nuts to steel components is also known. However, resistance welding, and in particular projection welding of such fasteners to some high strength steel grades can be problematic. For example, proper welding of carbon steel weld nuts to advanced high strength steels can result in a weld joint with less than desired strength, ductility, etc. In addition, proper welding of carbon steel weld nuts to aluminized ultra high strength steels, without the use of expensive capacitive discharge resistance welding machines, has remained elusive. Therefore, an improved process for welding carbon steel weld nuts to steel components would be desirable.

### SUMMARY OF THE INVENTION

A process for projection welding a steel weld nut to a steel component is provided. The process includes providing a direct current (DC) projection welding machine, a steel weld nut having at least one projection extending from a bottom surface of the weld nut and a high strength steel component. The weld nut is placed at a predetermined location on the steel component such that the at least one projection is in direct contact therewith. In addition, a force is applied to the weld nut in a direction towards the steel component such that pressure is applied to hold the weld nut into contact with the steel component before, during and after the weld nut is welded thereto.

The DC projection welding machine passes a predetermined electrical current through the weld nut and the at least one projection that is in direct contact with the steel component for a predetermined amount of weld time. The current in combination with the applied force creates a resistance weld joint (sometimes simply referred to as a “weld”) between the weld nut and the steel component. However, and in contrast to the prior art, the predetermined amount of weld time for the process disclosed herein is less than 1 Hertz (16.67 seconds). Finally, the weld joint between the weld nut and the steel component has a twist off strength of greater than 30.0 newton meters (Nm).

In some instances, the steel weld nut has at least two projections extending from the bottom surface. Also, the steel weld nut can be made from an extra low carbon steel alloy or an ultra-low carbon steel alloy. The steel weld nut can be any size and shape, for example and illustratively including sizes referred to those skilled in the art as M5 (5 millimeter (mm) thread hole diameter), M6 (6 mm thread hole diameter) and M8 (8 mm thread hole diameter) weld nuts.

The steel component is made from a high strength steel (HSS) with a yield strength equal to or greater than 210 megapascals (MPa), a high-strength low alloy steel (HSLA) with a yield strength generally between 280 to 550 MPa, an advanced high strength steel (AHHS) with a yield stress equal to or greater than 550 MPa, an ultra high strength steel (UHSS) with a tensile strength equal to or greater than 780 MPa, or a Gigapascal steel with a tensile strength equal to or greater than 1000 MPa. The steel component can be made from steel sheet and the sheet can have a thickness of less than 5 millimeters (mm), preferably less than less than 2.5 mm. Also, the steel sheet may or may not be galvanized or aluminized such that a zinc-based or aluminum-based coating, respectively, is present on the surface of the steel sheet.

The force applied to the weld nut is typically between 0.5-7.0 kilonewtons (kN) and it can be applied during a “squeeze time” of between 100-500 milliseconds (msec), a weld time of less than 16.67 seconds (sec) and a hold time of between 50-300 msec. The weld time, i.e. the time when the current is passing through the at least one projection can be less than 12 msec, 10 msec or 8 msec. Also, the current can be equal to or greater than 10 kiloamps (kA), 20 kA or 30 kA.

The result of the inventive process is a weld nut that is securely attached to the steel component. For example, the weld joint between the weld nut and the steel component can have a twist off strength equal to or greater than 30 Nm as noted above, equal to or greater than 40 Nm, or equal to or greater than 50 Nm.

### BRIEF DESCRIPTION OF THE DRAWINGS

FIG. 1A is a top perspective view of a weld nut with a hex shaped head;

FIG. 1B is a bottom perspective view of the weld nut shown in FIG. 1A illustrating banana shaped projections extending from a bottom surface of the weld nut;

FIG. 2A is a top perspective view of a weld nut with a collar shaped head;

FIG. 2B is a bottom perspective view of the weld nut shown in FIG. 2A illustrating conical shaped projections extending from a bottom surface of the weld nut;

FIG. 3A is a top perspective view of a weld nut with a square shaped head;

FIG. 3B is a bottom perspective view of the weld nut shown in FIG. 3A illustrating pyramid shaped projections extending from a bottom surface of the weld nut;

FIG. 4 is a flow chart illustrating a process according to an embodiment to the present invention.

### DETAILED DESCRIPTION OF THE INVENTION

A process for projection welding a steel weld nut to a steel component is provided. As such, the process disclosed herein has use in manufacturing processes such as the manufacturing of motor vehicles.

The process includes providing a direct current (DC) projection welding machine, a steel weld nut having at least one projection extending from a bottom surface of the weld nut and a high strength steel component. The weld nut is placed at a predetermined location on the steel component such that the at least one projection is in direct contact therewith. In addition, a force is applied to the weld nut in a direction towards the steel component such that pressure is applied to hold the weld nut into contact with the steel component before, during and after the weld nut is welded to thereto. The DC projection welding machine passes a current through the at least one projection that is in direct contact with the steel component a predetermined amount of weld time, which in turn creates a resistance weld joint (sometimes simply referred to as a “weld”) between the weld nut and the steel component as is known to those skilled in the art. However, and in contrast to the prior art, the predetermined amount of weld time is less than 1 Hz (16.67 sec). Finally, the weld joint between the weld nut and the steel component has a strength known to those skilled in the art as a “twist off strength” greater than 30.0 newton meters (Nm).

It is appreciated that projection welding is a modification of spot resistance welding. In particular, weld joints are localized by means of raised sections, or projections, that extend from one or both work pieces to be joined. With respect to the projection welding of weld nuts to a steel component, the passing of current through the projections and into the steel component results in heat being concentrated at the projections. The projections and the localized area of the steel component in contact with the projections melt, and in combination with the pressure applied to the weld nuts, a weld joint is formed. The projections also permit resistance welding of heavier sections or the closer spacing of welds. Finally, the projections can be used to assist in the positioning a weld nut at a desired location on the steel component.

In some instances, the steel weld nut has at least two projections extending from the bottom surface and can be made from an extra low carbon steel alloy or an ultra-low carbon steel alloy. The steel weld nut can be any size and shape, for example and illustratively including M5, M6 and M8 weld nuts.

The steel component is made from a high strength steel (HSS) with a yield strength equal to or greater than 210 megapascals (MPa), a high-strength low alloy steel (HSLA) with a yield strength generally between 280 to 550 MPa, an advanced high strength steel (AHHS) with a yield stress equal to or greater than 550 MPa, an ultra high strength steel (UHSS) with a tensile strength equal to or greater than 780 MPa or a Gigapascal steel with a tensile strength equal to or greater than 1000 MPa. The steel component can be made from sheet material that has a thickness of less than 5 millimeters (mm) and preferably less than less than 2.5 mm. Also, the steel sheet may or may not be galvanized or aluminized steel sheet.

The force applied to the weld nut is typically between 0.5-7.0 kN that is applied during a “squeeze time” of between 100-500 ms, a weld time of less than 16.67 seconds and a hold time of between 50-300 msec. The weld time, i.e. the time when the current is passing through the at least one projection, can be less than 12 msec, 10 msec or 8 msec. Also, the current can be equal to or greater than 10 kA, 20 kA or 30 kA.

In some instances, the steel component is an UHSS component that is coated with a zinc-base or aluminum-base coating, for example a galvanized or aluminized steel component, respectively. For example, the steel component can be made from USIBOR steel supplied by AcerlorMittal. In addition, the process includes using a direct current (DC) projection welding machine with a relatively short weld time, e.g. less than 16.67 msec, and produces weld joints that have desired tensile, shear and/or torque strength between the weld nut and the steel component.

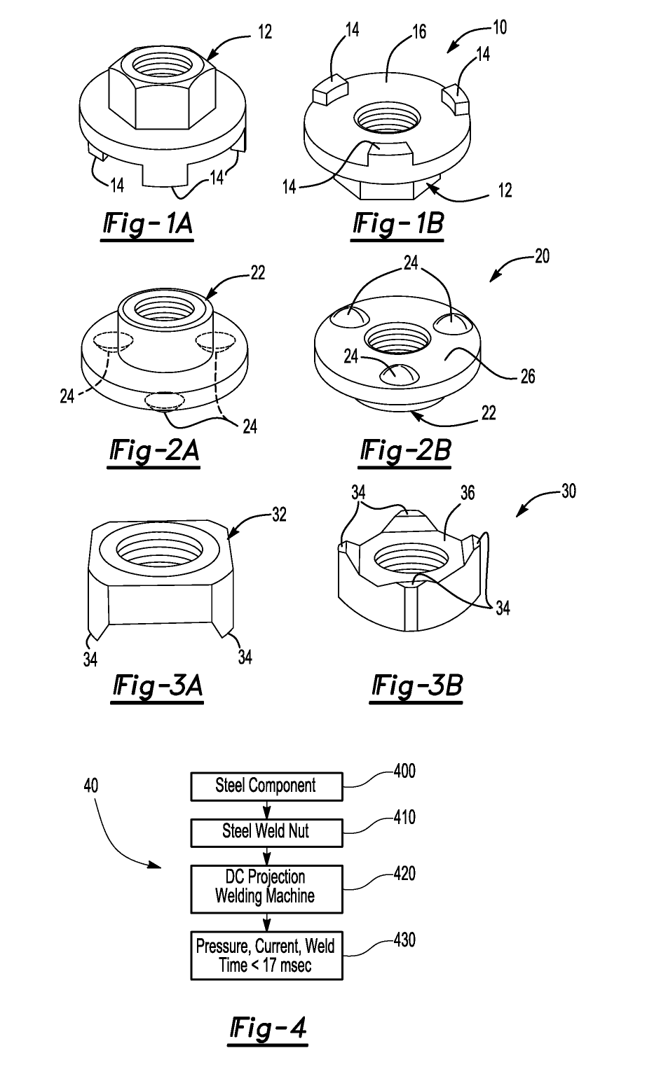

Turning now to FIGS. 1-3, schematic illustrations of three different weld nuts are shown. In particular, FIGS. 1A and 1B illustrate a weld nut 10 with a hex shaped head 12 and three banana shaped projections 14 extending from a bottom surface 16. FIGS. 2A and 2B illustrate a weld nut 20 with a collar shaped head 22 and three conical shaped projections 24 extending from a bottom surface 26. Finally, FIGS. 3A and 3B illustrate a weld nut 30 with a square shaped head 32 and four pyramid shaped projections 34 extending from a bottom surface 36.

A process for the welding of a steel weld nut to a steel component according to an embodiment of the present invention is shown in FIG. 4 at reference numeral 40. The process 40 includes providing a steel component at step 400 and a steel weld nut at step 410. The steel component and weld nut are assembled with a DC projection welding machine at step 420 as is known to those skilled in the art. In addition, a predetermined force/pressure, weld current and weld time is applied to the weld nut-steel assembly at step 430. It is appreciated that the weld time is less than 17 msec, e.g. less than 16.67 msec, and that the predetermined pressure, weld current and weld time provide a weld joint between the weld nut and the steel component that meets or exceeds desired mechanical properties.

Typical welding parameters for heretofor known processes are shown in Tables 1-4. As shown in the tables, weld times range from 3 to 230 cycles (1 cycle=1 Hertz= 1/60^{th} second) depending on the thickness of the thinnest piece being welded. Based on such data, weld times, electrode force and weld current for the welding of M5, M6 and M8 sized weld nuts onto UHSS sheet with thicknesses in the 1-3 mm range have ranged from 3-50 cycles (50-833 msec), 0.4-7.3 kN and 1.8-14.1 kA, respectively. However, such parameters have not provided weld joints with acceptable mechanical properties, for example adequate torque strength for M6 weld nuts projection welded onto 1.8 mm USIBOR aluminized sheet.

TABLE 1

| | Base | | Elec- | | | | |
|---|---|---|---|---|---|---|---|
| Thick- | Diam- | | trode | | | Weld- | Min- |
| ness | eter | Height | Contact | Elec- | Weld | ing | imum |
| of Thin- | of Pro- | of Pro- | Diam- | trode | Time | Cur- | Shear |
| nest | jection | jection | ater | Force | (Cy- | rent | Strength |
| Piece | (in) | (in) | (in) | (lbs) | cles) | (kA) | (lbs) |
| 0.025 | 0.081 | 0.020 | 0.187 | 200 | 6 | 4.5 | 525 |
| 0.031 | 0.094 | 0.022 | 0.187 | 300 | 8 | 5.1 | 740 |
| 0.034 | 0.094 | 0.022 | 0.187 | 350 | 10 | 5.4 | 900 |
| 0.044 | 0.119 | 0.028 | 0.250 | 480 | 13 | 6.5 | 1080 |
| 0.050 | 0.119 | 0.028 | 0.250 | 580 | 16 | 7.1 | 1500 |
| 0.062 | 0.156 | 0.035 | 0.312 | 750 | 21 | 8.4 | 2100 |
| 0.070 | 0.156 | 0.035 | 0.312 | 900 | 24 | 9.2 | 2550 |
| 0.078 | 0.187 | 0.041 | 0.375 | 1050 | 26 | 10.5 | 2950 |
| 0.094 | 0.218 | 0.048 | 0.500 | 1300 | 32 | 11.8 | 3700 |
| 0.109 | 0.250 | 0.054 | 0.500 | 1650 | 38 | 13.3 | 4500 |

Data taken from http://www.spotweldingconsultants.com/CMW_catalog.pdf

TABLE 2
Data for Single Projection

| | | Diam- | | | | Weld- | Min- |
|---|---|---|---|---|---|---|---|
| Thickness of | | eter | Height | Elec- | Weld | ing | imum |
| Thinnest Piece | | of Pro- | of Pro- | trode | Time | Cur- | Shear |
| | Thickness | jection | jection | Force | (Cy- | rent | Strength |
| Gauge | (in/mm) | (in) | (in) | (lbs) | cles) | (kA) | (lbs) |
| 21 | .033/0.84 | .110 | .035 | 240 | 3 | 6.6 | 700 |
| 19 | .042/1.07 | .110 | .035 | 330 | 5 | 8.0 | 1060 |
| 18 | .048/1.22 | .140 | .038 | 400 | 8 | 8.8 | 1300 |
| 16 | .060/1.52 | .150 | .042 | 550 | 10 | 10.3 | 1800 |
| 14 | .075/1.91 | .180 | .048 | 800 | 14 | — | 2425 |
| 13 | .090/2.29 | .210 | .050 | 1020 | 16 | 13.15 | 3250 |
| 12 | .105/2.67 | .240 | .055 | 1250 | 19 | 14.10 | 3850 |

Data taken from Resistance Welding Manual, Revised 4^{th} Edition, Resistance Welder Manufacturers' Association Alliance (RWMA), 2003, p. 3-14.

TABLE 3
Data for 2 or 3 Projections

| | | | | | Minimum |
|---|---|---|---|---|---|
| | | | Electrode | Welding | Shear |
| | | | Force per | Current | Strength |
| Thickness of Thinnest Piece | | Weld | Each | per Each | per Each |
| | Thickness | Time | Projection | Projection | Projection |
| Gauge | (in/mm) | (Cycles) | (lbs) | (kA) | (lbs) |
| 25 | .021/0.53 | 6 | 150 | 3.85 | 325 |
| 23 | .027/0.69 | 6 | 150 | 4.45 | 425 |
| 21 | .033/0.84 | 6 | 150 | 5.1 | 525 |
| 19 | .042/1.07 | 10 | 210 | 6.0 | 875 |
| 18 | .048/1.22 | 16 | 270 | 6.5 | 1100 |
| 16 | .060/1.52 | 20 | 365 | 7.65 | 1575 |
| 14 | .075/1.91 | 28 | 530 | 8.85 | 2150 |
| 13 | .090/2.29 | 32 | 680 | 9.75 | 2800 |
| 12 | .105/2.67 | 38 | 830 | 10.6 | 3450 |

Data taken from Resistance Welding Manual, Revised 4^{th} Edition, Resistance Welder Manufacturers' Association Alliance (RWMA), 2003, p. 3-14.

TABLE 4
Data for 4 or More Projections

| | | | | | Minimum |
|---|---|---|---|---|---|
| | | | Electrode | Welding | Shear |
| | | | Force per | Current | Strength |
| Thickness of Thinnest Piece | | Weld | Each | per Each | per Each |
| | Thickness | Time | Projection | Projection | Projection |
| Gauge | (in/mm) | (Cycles) | (lbs) | (kA) | (lbs) |
| 25 | .021/0.53 | 6 | 80 | 2.9 | 290 |
| 23 | .027/0.69 | 8 | 100 | 3.3 | 340 |
| 21 | .033/0.84 | 11 | 125 | 3.8 | 425 |
| 19 | .042/1.07 | 15 | 160 | 4.3 | 720 |
| 18 | .048/1.22 | 19 | 220 | 4.4 | 875 |
| 16 | .060/1.52 | 25 | 330 | 5.4 | 1225 |
| 14 | .075/1.91 | 34 | 470 | 6.4 | 1750 |
| 13 | .090/2.29 | 42 | 610 | 7.2 | 2325 |
| 12 | .105/2.67 | 50 | 740 | 8.3 | 2900 |

Data taken from Resistance Welding Manual, Revised 4^{th} Edition, Resistance Welder Manufacturers' Association Alliance (RWMA), 2003, p. 3-14.

In contrast, Table 5 provides measured torque strength data for M6 weld nuts welded to a 1.8 mm thick USIBOR aluminized sheet. The weld time was 6 msec, the electrode force was 4.22 kN and the weld current was 30.0 kA. In addition, the twist off torque strength was well above a minimum required torque strength of 34.82 Nm per ASTM Standard.

TABLE 5

| | Twist Off Strength (Nm) | | | |
|---|---|---|---|---|
| Part No. | Weld Nut 1 | Weld Nut 2 | Weld Nut 3 | Weld Nut 4 |
| 1 | 60.0 | 62.7 | 58.5 | 61.4 |
| 2 | 59.8 | 58.5 | 59.6 | 61.2 |
| 3 | 61.9 | 59.4 | 61.0 | 61.3 |
| 4 | 45.8 | 58.8 | 53.7 | 61.8 |
| 5 | 57.0 | 61.5 | 60.8 | 57.8 |
| 6 | 53.7 | 64.5 | 43.7 | 63.0 |
| 7 | 51.7 | 61.8 | 50.0 | 60.5 |
| 8 | 61.2 | 62.7 | 58.6 | 65.1 |
| 9 | 58.2 | 51.3 | 58.0 | 61.2 |
| 10 | 63.3 | 61.2 | 61.8 | 64.6 |

It is appreciated that the 6 msec weld time is a factor of 8 less than the minimum heretofor known weld times for such projection welds. As such, it is also appreciated that such a short weld time, in addition to the other welding parameters, provide unexpected results.

The process can also provide extended electrode tip life due to a reduction of force and/or heat applied to the weld nut during the welding process. Patch welded components joined by spot welding can also have weld nuts welded thereon using the inventive process. For example, patch welded components having a double layer of steel sheet can have a weld nut projection welded thereon without the removal of one of the steel sheet layers.

It is appreciated that the projection welding process disclosed herein can obey a relation such as:

αA·δF·λt_{w}=C

where A is amperage, F is applied force, t_{w} is weld time, and α, δ, λ and C are constants, variables, strength values and/or the like.

Embodiments described above are for illustrative purposes only and it should be appreciated that one skilled in the art could make changes, modifications, etc. and still be within the scope of the present invention. As such, the scope of the invention is defined by the claims and all equivalents thereof.

We claim:

1. A process for projection welding a steel weld nut to a steel component comprising:
providing a direct current (DC) projection welding machine;
providing a steel weld nut having a bottom surface, the bottom surface having at least one projection extending therefrom;
providing a steel component to have the steel weld nut welded thereto;
placing the steel weld nut at a predetermined location on the steel component with the at least one projection in direct contact with the steel component;
applying a force to the steel weld nut in a direction towards the steel component; and
passing a current through the at least one projection in direct contact with the steel component using the DC projection welding machine for a predetermined amount of weld time, the predetermined amount of weld time being less than 1 Hz and the current passing through the at least one projection producing a weld joint between the steel weld nut and the steel component, the weld joint having a twist off strength greater than 30.0 newton meters (Nm).

2. The process of claim 1, wherein the steel weld nut has at least two projections extending from the bottom surface of the steel weld nut.

3. The process of claim 2, wherein the steel weld nut is made from an extra low carbon steel alloy or an ultra-low carbon steel alloy.

4. The process of claim 3, wherein the steel weld nut is selected from the group consisting of an M5 weld nut, an M6 weld nut and an M8 weld nut.

5. The process of claim 1, wherein the steel component is made from an ultra high strength steel (UHSS) alloy.

6. The process of claim 5, wherein the steel component is an UHSS aluminized sheet having a thickness of less than 5 millimeters.

7. The process of claim 6, wherein the UHSS aluminized sheet has a thickness of less than 2.5 mm.

8. The process of claim 6, wherein the force is applied to the steel weld nut during a squeeze time, the weld time and a hold time.

9. The process of claim 8, wherein the force is between 0.5 and 7.0 kN.

10. The process of claim 9, wherein the squeeze time is between 100-500 msec.

11. The process of claim 10, wherein the weld time is less than 12 msec.

12. The process of claim 11, wherein the weld time is less than 10 msec.

13. The process of claim 12, wherein the weld time is less than 8 msec.

14. The process of claim 10, wherein the hold time is between 50-300 msec.

15. The process of claim 14, wherein the current is equal to or greater than 10 kA.

16. The process of claim 15, wherein the current is equal to or greater than 20 kA.

17. The process of claim 16, wherein the current is equal to or greater than 30 kA.

18. The process of claim 1, wherein the twist off strength is greater than 40 Nm.

19. The process of claim 18, wherein the twist off strength is greater than 50 Nm.

20. A process for welding a carbon steel fastener to a steel component comprising:
providing a steel component made from UHSS aluminized sheet having a thickness of less than 3.0 mm;
providing a steel weld nut having at least one projection;
providing a direct current (DC) projection welding machine;
placing the at least one projection of the steel weld nut into direct contact with the steel component at a predetermined location;
applying a force of between 0.5-7.0 kN onto the steel weld nut in a direction towards the steel component;
passing a welding current of at least 20 KA through the weld nut using the DC projection welding machine for a time period of less than 16.67 msec, the welding current producing a weld joint between the steel component and the steel weld nut, the weld joint having a twist off strength of at least 30 Nm.
